(19) United States
(12) Patent Application Publication
(10) Pub. No.: US 2026/0318704 A1
(43) Pub. Date: Oct. 15, 2026

(54) SPATIOTEMPORAL WORLD MODEL

(71) Applicant: Tera AI, Inc., San Francisco, CA (US)

(72) Inventors: Héctor CARRIÓN, Northridge, CA (US); Haoyu ZHANG, San Francisco, CA (US); Matthew TRANG, Manassas, VA (US); Victor HERNANDEZ, Gurabo, PR (US); Emanuel RAMIREZ, Emeryville, CA (US); Ayush ZENITH, Andover, MA (US); Eric WEISS, Los Altos Hills, CA (US)

(21) Appl. No.: 19/462,920

(22) Filed: Jan. 28, 2026

Related U.S. Application Data
(60) Provisional application No. 63/750,670, filed on Jan. 28, 2025.
(60) Provisional application No. 63/753,832, filed on Feb. 4, 2025.
(60) Provisional application No. 63/807,381, filed on May 16, 2025.
(60) Provisional application No. 63/860,539, filed on Aug. 8, 2025.

(51) Int. Cl. G01C 21/00; G06N 3/0475

(52) U.S. Cl. CPC G01C 21/3837; G06N 3/0475

(57) ABSTRACT

There is provided a generative world model that models time as a navigable dimension for spatio-temporal prediction. The generative world model is configured to: receive a first spatio-temporal state, and navigate from the first spatio-temporal state to a second spatio-temporal state, different from the first spatio-temporal state. In some embodiments, navigating from the first spatio-temporal state to the second spatio-temporal state includes determining a trajectory through a time dimension and determining the second spatio-temporal state based on the determined trajectory and the first spatio-temporal state.

### CROSS-REFERENCE TO RELATED APPLICATIONS

This application claims the benefit of U.S. Provisional Application No. 63/860,539, filed Aug. 8, 2025, U.S. Provisional Application No. 63/807,381, filed May 16, 2025, U.S. Provisional Application No. 63/753,832, filed Feb. 4, 2025, and U.S. Provisional Application No. 63/750,670, filed Jan. 28, 2025, the contents of which are herein incorporated by reference in their entireties for all purposes.

### TECHNICAL FIELD

This invention relates generally to the foundation model field, and more specifically to a new and useful spatiotemporal model in the foundation model field.

### BACKGROUND

World models are crucial for agents to understand and interact with their environments, enabling prediction of future outcomes and informed decision-making. Early research employed world models for basic control tasks, relying on proprioceptive inputs to learn system dynamics. The emergence of visual world models marked a significant advancement, with methods using latent space representations to predict future states.

Recent transformer-based approaches like iVideoGPT have demonstrated scalable frameworks for predicting future visual observations based on action-conditioned sequences, showing strong generalization when pretrained on extensive interaction datasets. Diffusion models have further advanced the field, as seen in GameNGen, which enables real-time game simulation, and DayDreamer, which successfully applies diffusion-based models to physical robot learning tasks.

Generative video models have shown a remarkable capability to understand real world dynamics and interactions through realistic video synthesis. However, these models are difficult to precisely control via their simple textual-interfaces. Furthermore, they are not explicitly encouraged to densely study physical real-world environments through free-play.

While these approaches have shown impressive capabilities in modeling spatial dynamics, they typically treat time as a passive dimension for prediction rather than an active dimension for navigation. There therefore exists a need to explicitly model time as a navigable dimension and unify spatial and temporal navigation into a single coherent process, enabling real-time verification through interactive observation-action loops.

### BRIEF DESCRIPTION OF THE SEVERAL VIEWS OF THE DRAWINGS

FIG. 1 is a schematic representation of a variant of the method.

FIG. 2 is an illustrative example of iterative prompting and generation.

FIG. 3 is an illustrative example of determining the training data.

FIG. 4 is an illustrative example of using or training the world model to predict a spatial state, a temporal state, and a next observation measurement from an initial observation measurement.

FIG. 5 is an illustrative example of using or training the world model to predict a spatial action, a temporal action, and a next observation measurement from an initial observation measurement.

FIG. 6 is an illustrative example of an architecture for a spatio-temporal scrapper.

FIG. 7 is an illustrative example of a geographical distribution of street-view data used with various embodiments.

FIG. 8 is an illustrative comparison between TARDIS and previous image generation solutions.

FIG. 9 is an illustration of a qualitative analysis of self-control implemented by a model according to embodiments.

FIG. 10 is an illustration of temporal reasoning implemented by a model according to embodiments.

FIG. 11 is an illustration of georeferencing implemented by a model according to embodiments.

FIG. 12 is an illustrative example of a hardware architecture that operates a machine learning model.

FIG. 13 is a flowchart of a method for training a generative world model that models time as a navigable dimension for spatio-temporal prediction, according to an embodiment of the disclosure.

FIG. 14 is a flowchart of a method for determining, with a generative world model that models time as a navigable dimension for spatio-temporal prediction, a second spatio-temporal state from a first spatio-temporal state, according to an embodiment of the disclosure.

### DETAILED DESCRIPTION OF THE INVENTION

### Overview

Generative environmental models, or “world models”, are becoming an increasingly important component as generalist agents learn to plan, reason, and act upon their surroundings. The world is inherently dynamic, with both spatial and temporal dimensions fundamentally intertwined in ways that shape the perception and navigation of environments. There exists an intrinsic feedback loop between perception and action that characterizes natural navigation. This observation underscores a critical challenge in artificial intelligence: the need for systems that can dynamically reason about and navigate through both space and time.

Recent advances in world models and generative approaches have demonstrated capabilities in modeling complex environments. Traditional autonomous systems typically employ modular architectures that separate perception, mapping, prediction, and planning into distinct components. While this approach has proven effective for specific tasks, it often struggles with scenarios requiring dynamic temporal reasoning. Current video generation models, while impressive in their ability to synthesize temporal sequences, primarily focus on passive generation rather than interactive navigation and decision-making.

World models aim to simulate environments and enable effective agent behavior. However, modeling real-world environments presents unique challenges as they dynamically change across both space and time.

The key limitation of existing approaches lies in their treatment of time as a passive dimension rather than an actively navigable space. Consider an autonomous vehicle navigating through a city: its success depends not just on understanding where it is, but when it is—traffic patterns, weather conditions, and environmental states all vary significantly with time. Examples of autonomous vehicles may include self-driving road vehicles (e.g., a car, a truck, a motorcycles, a scooter), self-driving off-road vehicles (e.g., an ATV, a UTV, dirt bikes), self-driving flying vehicles (e.g., a unmanned aerial vehicle/drone, an airplane, a helicopter), and/or self-navigating robotic vehicle (e.g., a robot navigating a commercial, home, or factory environment). In some embodiments, an autonomous vehicle may include an electronic device (or computing system) having one or more processors and a non-transitory computer-readable storage medium for controlling one or more functions of the autonomous vehicle (e.g., instructions for moving the autonomous vehicle). Current systems typically handle this by: (1) treating temporal changes as external factors to react to, rather than dimensions to actively reason about, (2) separating spatial navigation from temporal prediction, leading to potential inconsistencies, and (3) focusing on immediate future prediction rather than comprehensive spatiotemporal planning.

In addition, modeling physical environments presents a distinct challenge: unlike most video games, the real world changes over time. For example, identical spatial locations could look differently between months as seasons change. As years pass, infrastructure and housing could be newly developed, removed, renovated or otherwise updated. Understanding and thus generalizing to these natural environ-mental shifts could be an important aspect towards robust generative world modeling.

While recent works explore this concept within synthetic settings with near-infinite observations, the present disclosure presents TARDIS: a real-world-model, grounded in rich, composable spatiotemporal permutations of true physical data.

TARDIS simultaneously models the relationship between egocentric views, positional coordinates and movement commands across both space and time. Robust performance is demonstrated across a range of agentic tasks such as controllable photorealistic image synthesis, positional extrapolation, instruction following, autonomous self-control, and georeferencing.

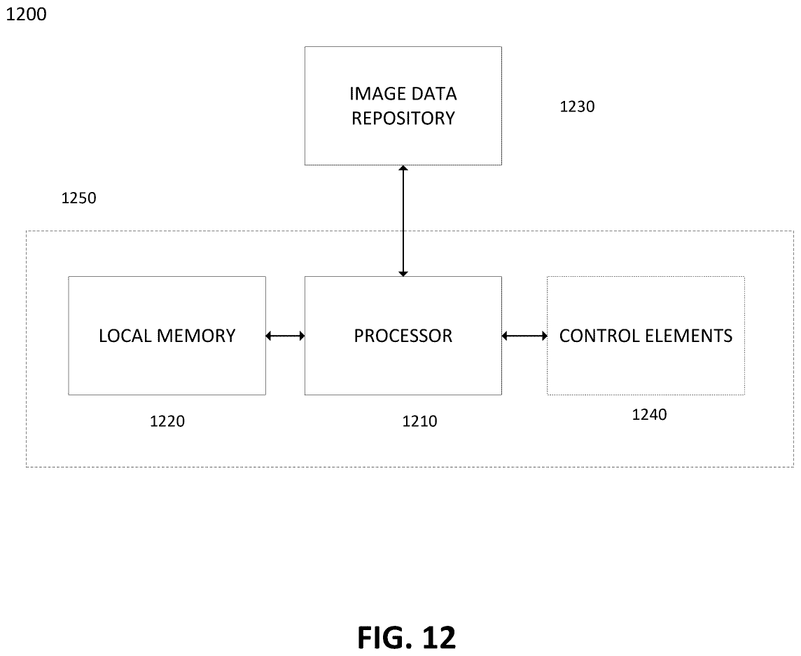

To capture these composed dynamics, a Spatio-Temporal Road Image Dataset for Exploration (STRIDE) is provided, permuting 360° panoramic imagery into rich interconnected observation, state and action nodes. Leveraging this structure, the relationship is simultaneously modelled between egocentric views, positional coordinates, and movement commands across both space and time. In some embodiments, the STRIDE dataset can be derived from image data in the image data repository 1230 shown in FIG. 12, and used by the processor 1210 and local memory 1220 shown in FIG. 12 for training a generative world model according to embodiments of the disclosure.

A unified framework is proposed that transforms these traditionally separate challenges into a single, coherent sequential prediction problem. This approach treats time as a fully traversable dimension, similar to spatial coordinates, enabling agents to: (1) determine their precise spatiotemporal coordinates from egocentric observation, (2) plan trajectories through both space and time simultaneously, (3) execute navigation actions in a continuous, interactive loop, and (4) verify and adapt predictions through real-time observation.

This framework differs fundamentally from existing world models in its treatment of temporal navigation. Rather than merely predicting future states, the present model allows agents to actively reason about and navigate through time, similar to how they navigate through space. This capability enables more sophisticated planning and decision-making in dynamic environments, where understanding temporal context is as crucial as spatial awareness.

The implications of this work extend beyond immediate applications in autonomous navigation. By demonstrating that temporal relationships can be actively modeled and traversed, new possibilities for developing AI systems arise that can reason about cause and effect in dynamic environments. These results show that this unified approach achieves robust performance in complex, time-varying environments, suggesting a promising direction for developing more sophisticated generalist agents capable of understanding and manipulating both the spatial and temporal aspects of their environment.

Through extensive experiments with egocentric vision-based navigation, it is demonstrated that the present sequential prediction framework can effectively (1) localize agents in both space and time from visual observations, (2) generate and execute complex spatiotemporal navigation plans, (3) adapt to dynamic environmental changes in real-time, and (4) produce verifiable predictions about future states.

It is demonstrated that a robust performance across a range of agentic tasks such as controllable photorealistic image synthesis, instruction following, autonomous self-control, and state-of-the-art geo-referencing is achieved. These results suggest a promising direction towards sophisticated generalist agents capable of understanding and manipulating the spatial and temporal aspects of their material environments.

These results suggest a promising direction towards sophisticated generalist agents capable of understanding and manipulating the spatial and temporal aspects of their material environments.

This also provides emergent properties, a robust model and a novel dataset that could serve the research community towards future real-world-models that can handle temporally dynamic settings in unseen environments. As generalist agents transition away from synthetic environments and onto the real world tools like TARDIS and STRIDE could enable novel tasks completion.

### Technical Overview

The present approach introduces a unified framework for spatiotemporal navigation that integrates multiple traditionally separate tasks into a cohesive sequential prediction problem. At its core, the model operates through an interactive, real-time loop that processes observations, determines location and time coordinates, and executes navigation actions. Unlike conventional world models that treat environments as static snapshots, the present framework explicitly incorporates time as a traversable dimension, enabling dynamic reasoning and planning.

To address these challenges, a Spatio-Temporal Road Image Dataset for Exploration or STRIDE is provided. This novel dataset connects and projects panoramic imagery into sequential multi-modal observation-state-action events, growing the base information by over 27× without the use of traditional data augmentation.

STRIDE turns real street-view panoramic observations into a navigable, interactive environment suitable for free-play across space and time.

This dataset is benchmarked via TARDIS, a transformer-based generative world model that integrates spatial and temporal dynamics through a unified autoregressive framework trained on STRIDE.

This dataset is leveraged to train TARDIS, a generative world model grounded in rich, composable spatiotemporal permutations of physical data. The present framework unifies traditionally separate challenges into a coherent sequential prediction problem, simultaneously modeling the relationship between egocentric views, positional coordinates, and movement commands across both space and time. Treating these traditionally separate problems as a single, integrated auto-regressive sequential prediction. The present main contributions are:

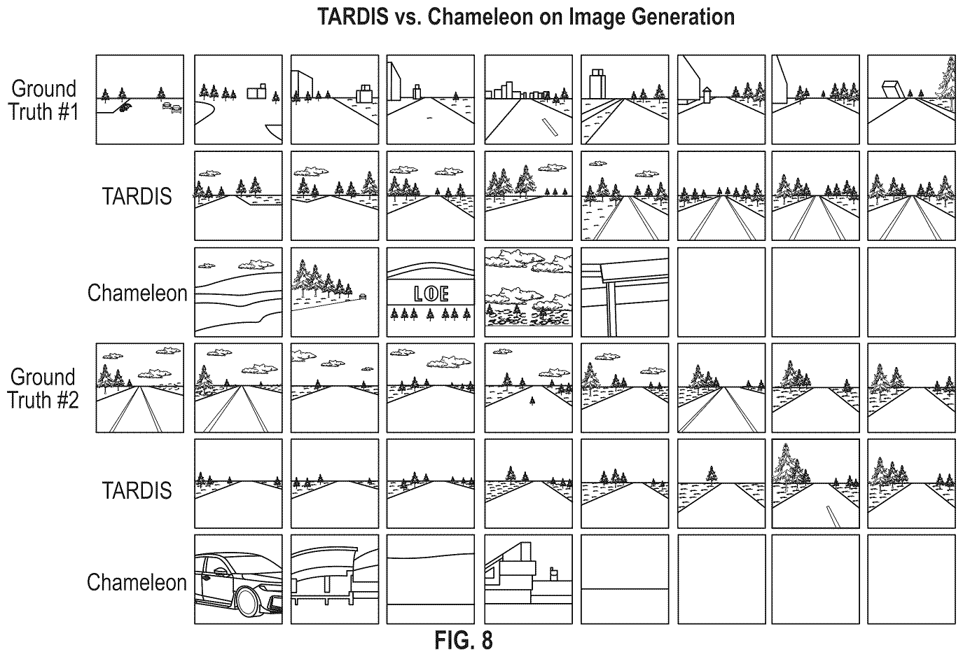

Controllable Spatiotemporal Generation: TARDIS can be explicitly instructed how to move, leading to fine-grain image generation control (structural dissimilarity SSIM<0.12 across seasonal transitions, 41% FID improvement over Chameleon7B (see FIG. 8)). Note that FIG. 8 illustrates a comparison between TARDIS vs. Chameleon Image generation, where TARDIS appears to more closely follow the image pattern and instructions. In addition, Chameleon smaller context length (4 k vs 16 k) impacts performance after 5 frames.

STRIDE Dataset: A novel dataset creation method which is highly flexible, composable and efficient.

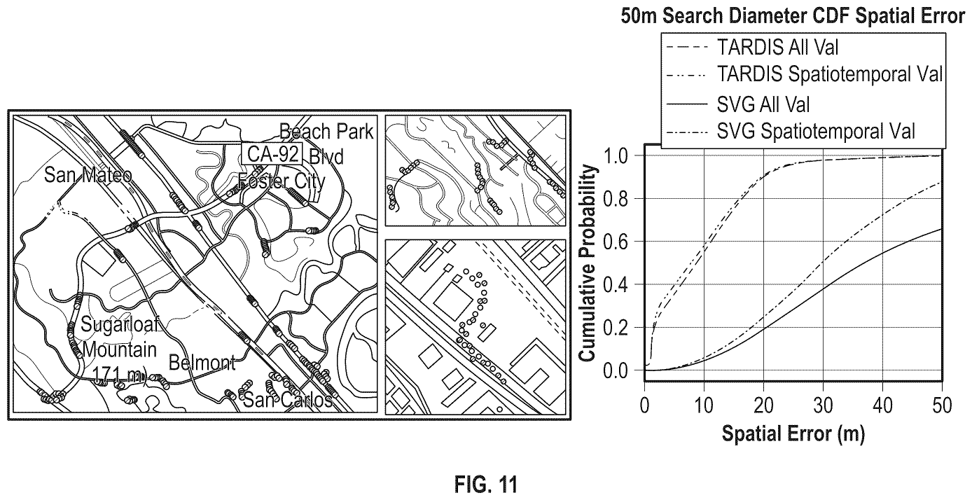

Georeferencing: includes explicit latitude and longitude predictions, achieving state-of-the-art meter-level precision (60% predictions<10 m error vs SVG's<10% at the same threshold (see FIG. 11)). Note that FIG. 11 (left) shows TARDIS georeferencing, with ground-truth locations and TARDIS coordinate predictions shown. Note that FIG. 11 (right) shows a CDF of TARDIS vs SVG with a 50 m search space. This describes the fraction of predictions within some distance threshold. In particular, TARDIS model has 60% of predictions within 10 m, and 90% of predictions within 20 m.

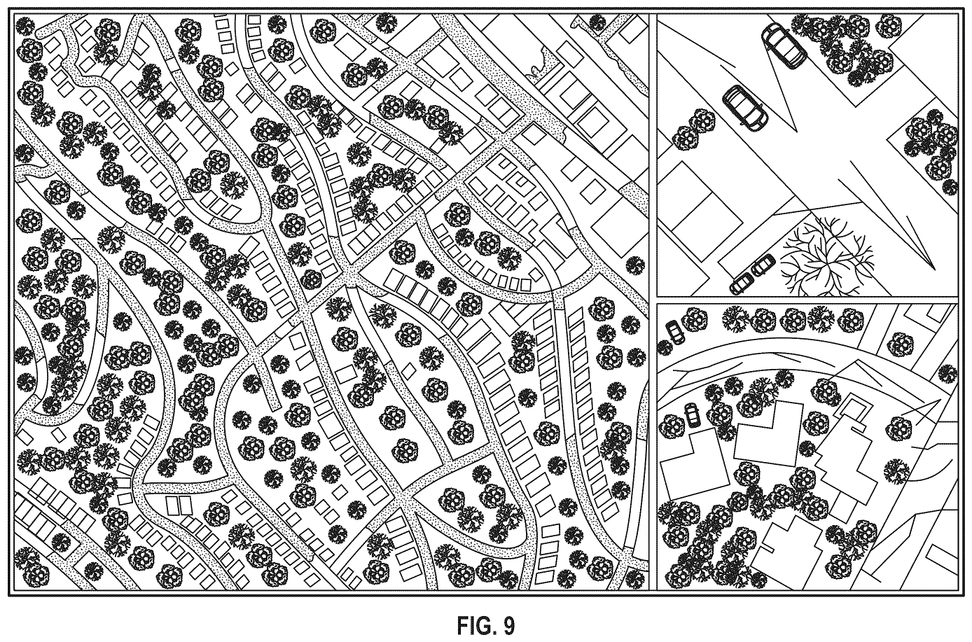

Valid Self-Control: an auto-regressive formulation allows the model to autonomously generate its own actions which is observed to be robust and consistent (77.4% road adherence at 4 m lane width, 70.5% valid non-trivial moves (see FIG. 9)). Note that in FIG. 9, arrowheads represent heading action, line length represents distance action generated by TARDIS. It can be observed that the majority of actions keep within the lane or onto driveways.

Temporal Sensitivity: By explicitly modeling time as a dimension, the system can adapt and leverage temporal changes, such the ability to predict changes or estimate position despite environmental changes (linear SSIM decay R2=0.94 over 5-year intervals, 18% greater infrastructure vs seasonal distortion).

Interactive Adaptation: The flexible sequential structure enables interactive updates and refinements of predictions based on new observations.

The sequential nature of the present approach can be formalized through a series of interconnected prediction tasks (i.e., a series of interrelated sequential tasks where observation influences state which influences actions and so on):

Spatial Localization: Given an egocentric observation Oₜ at time t (or step n), determine the spatial coordinates (x, y, z):

$${f}_{l o c} : {O}_{t} \to ( x , y , z ) ; or \qquad ( 1 )$$

$${f}_{l o c} : {O}_{t} \to ( x , y ) . \qquad ( 1 a )$$

In some examples, the x-coordinate corresponds to a latitude (latₙ), and the y-coordinate corresponds to a longitude (lonₙ).
This function maps raw sensory input to precise geolocation coordinates, serving as the foundation for subsequent positioning and navigation tasks/predictions.

Temporal Localization: Given the observation Oₜ and spatial coordinates (x, y, z), determine the temporal position t.

$${f}_{t i m e} : ( {O}_{t} , x , y , z ) \to t . \qquad ( 2 )$$

In some examples, the temporal location only uses x and y coordinates according to (1b) above. In some examples, the temporal position t includes a temporal position month, m, and/or a temporal position year, y. In some examples, the spatial and temporal positions (x, y, z, t) may be referred to together as state Sₜ, or Sₙ.
This enables the model to situate itself not only in space but also in time, crucial for understanding the dynamic environmental changes.

Action Selection: Using the complete spatiotemporal context, determine the optimal navigation action aₜ:

$${f}_{a c t i o n} : ( {O}_{t} , x , y , z , t ) \to {a}_{t} . \qquad ( 3 )$$

The action space aₜ (otherwise referred to as an) includes movement commands that can affect both spatial and temporal dimensions. This can be reflected by spatial action formula (3a) and temporal action formula (3b), below. In the below, fₛₐ is a spatial action function that determines the navigational move distance in meters dₙ and heading in degrees hₙ. In the below, action in the temporal direction, expressed as month change Δmₙ and year change Δyₙ, is explicitly allowed via temporal action function fₜₐ.

$${f}_{s a} : ( {O}_{t} , {S}_{n} ) \to ( {d}_{n} , {h}_{n} ) . \qquad ( 3 a )$$

$${f}_{action} : ( {O}_{t} , {S}_{n} ) \to ( Δ {m}_{n} , Δ {y}_{n} ) . \qquad ( 3 b )$$

Destination Prediction: Given the current state and selected action, predict the resulting destination state:

$${f}_{d e s t} : ( {O}_{t} , x , y , z , t , {a}_{t} ) \to ( {x}^{′} , {y}^{′} , {z}^{′} , {t}^{′} ) . \qquad ( 4 )$$

This can be alternatively expressed by the following:

$${f}_{d e s t} : ( {O}_{n} , {S}_{n} , {a}_{n} ) \to {O}_{n + 1} . \qquad ( 4 a )$$

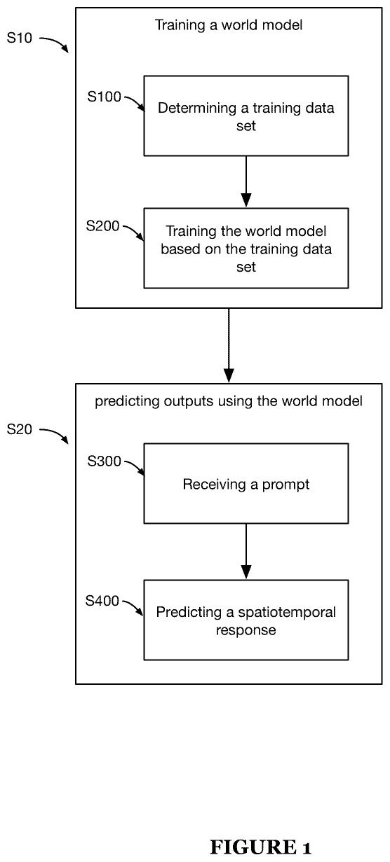

This enables forward planning and verification of navigation outcomes. This enables forward planning, as the auto-regressive cycle continues along the next function fss for step n+1. The cycle is visualized on FIG. 1.

This auto-regressive dynamics of TARDIS implements a Markovian process. This emerges naturally from STRIDE's graph structure FIG. 1, where node transitions depend only on immediate neighbors. To see this, for notational simplicity, let us emphasize state-action space decompositions (enabled by conditioning events denoted by ⋅|⋅): At step n

$${S}_{n} \vert {O}_{n} = ( {lat}_{n} , {lon}_{n} , {m}_{n} , {y}_{n} ) \vert {O}_{n} ; and$$

$${A}_{n} \vert \{ {S}_{n} , {O}_{n} \} = ( {d}_{n} , {h}_{n} , Δ {m}_{n} , Δ {y}_{n} ) \vert \{ {S}_{n} , {O}_{n} \}$$

In addition to state and action decompositions, the Markovian structure is further validated through observation transitions depending solely on Sₙ and Aₙ, independent of history. This Markovian structure ensures dependencies remain localized to immediate context, validated by STRIDE's OSM-grounded transitions where:

$$P \vert ( {S}_{t + 1} \vert {S}_{t} , {A}_{t} ) > 0 ↔ ∃ valid road path {S}_{t} \to {S}_{t + 1}$$

as defined through OpenStreetMap network constraints.

The key innovation in this approach lies in treating these traditionally separate problems as a single, integrated sequence of predictions.

This unified treatment offers several advantages: (1) Temporal Sensitivity: By explicitly modeling time as a dimension, the system can maintain sensitivity to the time. (2) Cross-task Learning: Information learned in one pre-diction task can inform and improve performance in others. (3) On the fly Adaptation: The sequential structure enables continuous updating and refinement of predictions based on new observations. (4) Verifiable Predictions: The model's predictions about future states can be verified against actual observations, enabling self-correction and learning.

This formulation transforms the traditional navigation problem into a more comprehensive spatiotemporal reasoning task, where the agent continuously updates its understanding of both where and when it is while planning and executing navigation actions.

Through comprehensive evaluation, TARDIS's performance is demonstrated across multiple agentic tasks, including georeferencing, controllable photorealistic image synthesis, autonomous self-control, and a robust understanding of time. The present results suggest that this unified approach achieves strong baseline performance in complex, time-varying environments, suggesting promising future research directions.

### Detailed Description of Embodiments

The following description of the embodiments of the invention is not intended to limit the invention to these embodiments, but rather to enable any person skilled in the art to make and use this invention.

As shown in FIG. 1, variants of the method can include: training a world model S10; and predicting outputs using the world model S20. The method functions to provide a spatiotemporal world model capable of predicting real-world measurements, geolocations for a given measurement, the timestamp for a given measurement, and/or high-probability next actions.

All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

In an illustrative example, the method can generate and predict spatial-temporal trajectories by processing sequential observation measurements, states, and/or actions through an autoregressive transformer model. The world model can tokenize input data (e.g., images, coordinates, timestamps, etc.) and can either generate or be prompted with specific tokens to predict states (e.g., observation location, observation time), actions (e.g., next pose change, next temporal change), and/or subsequent observation measurements. For observation, Chameleon's tokenizer is utilized. For geolocation tokenization, different from the related works, discrete tokens are utilized. The discrete categorical output from a model naturally forms a probabilistic distribution that one can easily sample from, enabling flexible conditional generation. For time, discrete tokenization is utilized too. The world model can maintain legal navigation constraints by constructing the training data based on road network data and driving rules, and can operate across different time periods while preserving spatial consistency by training on observations for the same geolocation from different timeframes, enabling both trajectory prediction and visual scene generation based on the predicted path. However, the method can be otherwise performed.

Variants of the technology can confer one or more advantages over conventional technologies.

First, variants of the technology can eliminate the need for explicit simulators or planners by learning valid actions directly from real-world data in an end-to-end manner. By integrating action learning within a unified framework, the computational overhead associated with maintaining separate simulation and planning modules can be reduced. For example, traditional approaches may require distinct models for simulating vehicle dynamics and planning trajectories, whereas the present technology can accomplish both tasks through a single model. This integration can lead to more efficient processing pipelines that can consider more information extracted from the observations while maintaining legal driving behaviors (e.g., staying on roads, following traffic rules, etc.). The end-to-end nature of the system can also potentially reduce the propagation of errors that typically occur at the interfaces between separate modules in conventional systems.

Second, variants of the technology can enable more constrained, realistic measurement simulation with enhanced predictive capabilities. In examples, the model can demonstrate approximately 80% prediction accuracy within 15 meters, which can represent a significant improvement over conventional simulation approaches. By handling temporal dynamics through the prediction of environmental changes over time, the system can also achieve greater robustness compared to traditional simulators that typically operate in a single time snapshot. Additionally, the system can be periodically grounded with real observations to prevent divergence while still maintaining the ability to imagine future states, which can provide a balance between simulation fidelity and predictive power that can be difficult to achieve with conventional methods.

However, further advantages can be provided by the system and method disclosed herein.

Training a world model S10 functions to provide a world model capable of multimodal, sequential observation predictions. The world model can be trained: once, when new data is available, for each new deployment region (e.g., for each new city or geographic region that the model will be used within), when model metrics fall below a threshold (e.g., accuracy, precision, recall, etc.), and/or at any other time. The world model can be trained by a centralized system, by an edge system, and/or by any other system.

In variants, training a world model S10 can include: determining a training data set S100; and training the world model based on the training data set S200. However, the world model can be otherwise trained.

Determining a training data set S100 functions to aggregate and establish valid navigational connections between disparate observations, which can enable the model to learn valid actions (e.g., navigation paths, temporal changes, etc.) while respecting physical and traffic constraints.

The training data set can be determined from a set of real world observations, a set of simulated observations, and/or any other set of observations. Each observation can include: one or more measurements sampled from one or more angles, a geolocation (e.g., spatial state), a timestamp (e.g., temporal state), and/or any other information. The measurements can include: images, depth measurements, audio, and/or any other measurement of the environment in any suitable modality. The measurements can be: a panoramic image, 360 image, single frame image, and/or any other type of image. When the real world observations are multi-frame images (e.g., panoramas, 360 images, etc.), the training data set can be generated by generating single frames from each multi-frame image. For example, each panoramic image can be projected into one or more viewing angles (e.g., each cardinal direction, 4 directions aligned with or orthogonal to the respective street's direction of travel, etc.). In variants, this can create “look around” data for each observation. However, the multi-frame images can be used as-is, without reducing the multi-frame image into a single-frame image. In an example, the training data set can include Google StreetView photos, drone images, OpenStreetCam images, and/or any other image sources.

The observation set can be organized into a navigation graph within the training data set, but can alternatively be unstructured or otherwise organized.

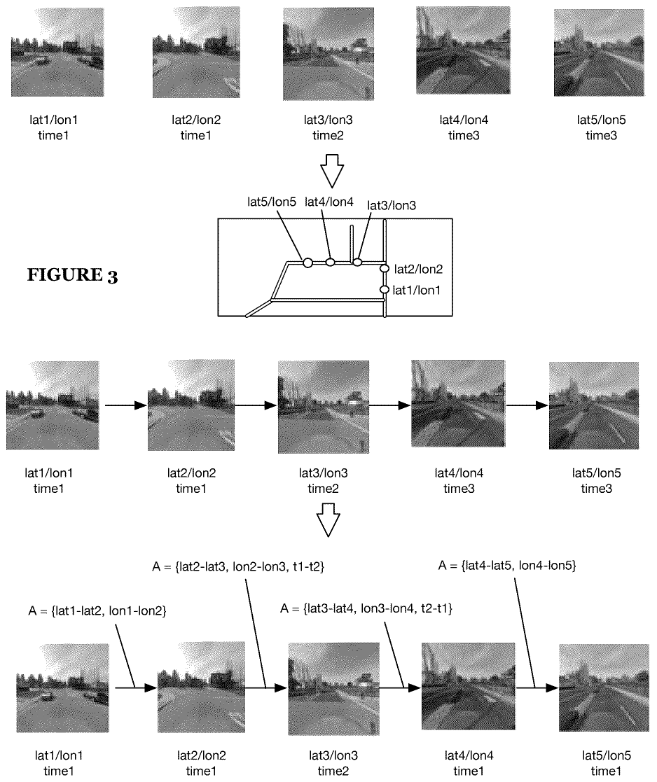

In variants, generating a navigation graph from the observation set can include: organizing the observations based on the respective spatiotemporal parameters, and connecting adjacent observations according to a set of rules. An example is shown in FIG. 3. Geographically and/or temporally adjacent observations are preferable connected by an edge in the navigation graph, but can alternatively be otherwise connected. Adjacent observations are preferably the nearest observations (e.g., immediate neighbor), but can alternatively be the kth neighboring observation, a non-local observation, and/or be otherwise determined. The navigation graph is preferably undirected (e.g., for training), but can alternatively be directed (e.g., to indicate valid traversal actions). The directions of the edges can be specified by: driving rules (e.g., drive on right side, etc.), the respective timestamps (e.g., wherein the edges point from earlier observations to later observations, etc.), and/or otherwise determined. The navigation graph is preferably unweighted, but can alternatively be weighted.

In a first example, adjacent observations associated with a common drivable feature (e.g., legally drivable road segment, etc.) can be connected together by an edge in the graph. Common drivable features can be determined from map data (e.g., OpenStreetMap (OSM) road data, etc.), and/or any other source. Examples of common drivable features can include: driveways, highways, parking lots, and/or any other drivable features.

In a second example, adjacent observations separated by a valid navigation action can be connected by an edge in the graph. The valid navigation action can be determined based on a set of navigation rules (e.g., nodes on the same side of the road can be connected, nodes on opposite sides of a divider cannot be connected, etc.), a map (e.g., OpenStreetMap (OSM) road data, etc.), driving rules (e.g., can only drive forward in the right lane of the road, etc.), and/or any other suitable determination method.

However, the adjacent observations can be otherwise connected.

The training data set preferably includes a set of navigation sequences (e.g., series of observations along a valid navigational route), but can additionally or alternatively include individual observations, and/or be otherwise constructed.

A navigation sequence can include a series of observations connected by a set of actions, or be otherwise defined. This can associate an action with each observation (e.g., the next valid action in a navigation sequence), which can enable the model to predict high-probability control actions given an observation. An action can represent the change between the node and the next node in the navigational sequence, or represent any other relationship between two observations. Actions between successive observations in a navigation sequence can be determined: from the difference in the states of the adjacent observations (e.g., difference between the geolocations, difference between the timestamps, etc.), from the navigation graph edges, and/or otherwise determined.

The set of navigation sequences are preferably generated from the navigation graph, but can alternatively be otherwise generated. In a first variant, generating the set of navigation sequences can include applying a set of driving heuristics (e.g., driving rules, etc.) to traverse the navigation graph. In a second variant, a depth-first search can be performed on each node (e.g., observation) in the navigation graph until a stop condition is met. The stop condition can be: a maximum number of paths for that node is reached or until a maximum number of samples per visual sequence is reached (both configurable parameters), whichever comes first; or be otherwise defined. However, the set of navigation sequences can be otherwise generated.

S100 can optionally include tokenizing the observations. Tokenizing the observations can optionally include tokenizing the observations into measurement tokens (O), state tokens(S), action tokens (A), and/or any other token types. In examples, the measurement tokens (O) can encode visual information, depth information, acoustic information, and/or other environmental measurement information. The state tokens(S) can encode the context of the observation, including location and time (e.g., the observation's or observer's state in the navigable universe). The action tokens (A) can encode spatiotemporal instructions. In a first example of tokenizing the observations, each observation token can include an observation-state pair (e.g., include O and S for the observation). In a second example of tokenizing the observations, each observation token can include an observation-state-action tuple (e.g., include O, S, and A for each observation). However, the observations can be otherwise tokenized.

In a specific example, tokenizing the observations can include tokenizing the one or more images of the observation (Oimage), the spatial coordinates (e.g., Slatitude, Slongitude), the temporal state (e.g., Smonth, Syear), optionally actions (e.g., Adisplacement, Arotation, Achange_month, Achange_year), and/or other dimensions of each observation (e.g., node). The images can be tokenized using a VQGAN image tokenizer, DALL-E image tokenizer, CLIP image tokenizer, Stable Diffusion VAE tokenizer, and/or any other image tokenizer. The spatial coordinates can be represented as a different token for each coordinate dimension (e.g., latitude, longitude, altitude, etc.), the temporal state can be represented as a different token for each temporal unit (e.g., month, year, day, etc.). The actions can be represented as a set of tokens for displacement (e.g., xyz displacement), a set of tokens for rotational change (e.g., pitch, yaw, roll, etc.), a set of tokens for temporal displacement (e.g., token for change in month, token for change in year, etc.), and/or otherwise represented. However, the observations can be otherwise tokenized.

As one example, shown in Table 1 below, the image vocabulary size for the image tokenization is 8192 with each image being represented as 1024 tokens. When decoding back into RGB space, the generated images are 512×512 pixels in size.

For all other modalities within S and A (this is to say: latitude, longitude, month, year, distance, heading, month change and year change), each numerical value is tokenized into discrete token bins. In order to cover the necessary range and resolution, more or fewer tokens are dynamically allocated based on the STRIDE dataset. For statistics on token assignment, value range and resolution see Table 1. The decision to tokenize into discrete categorical bins is motivated since the output from the model naturally forms a probabilistic distribution which it can be directly sampled from, enabling flexible conditional generation.

TABLE 1
Exemplary Tokenization

| | | Total | Possible Expressed |
|---|---|---|---|
| | Precision | Tokens | Range |
| Image | N/A | 8192 | N/A |
| Latitude | 1e⁻⁵ | 6723 | 37.50555, 37.57277 |
| Longitude | 1e⁻⁵ | 10000 | −122.34916, |
| | | | −122.259168 |
| Month | 1 | 12 | 1, 12 |
| Year | 1 | 31 | 2000, 2030 |
| Distance | 0.1 | 591 | 0.0, 50.0 |
| Heading | 0.1 | 3601 | 0.0, 359.9 |
| Δ Month | 1 | 12 | 0, 11 |
| Δ Year | 1 | 61 | −30, 30 |

In an illustrative example, an observation token (Ni) can include {Oimage, Slatitude, Slongitude, Smonth, Syear, Adisplacemeent, Arotation, Achange_month, Achange_year}, or be otherwise represented. An observation token can be otherwise constructed.

The tokens can include a single component of the tokenized data (e.g., a token for latitude, a token for longitude, a token for the month, a token for the year, etc.), be tokenized into discrete token bins, and/or any other token format, or include multiple components of the tokenized data (e.g., the components are concatenated into a single vector, wherein the vector is treated as the token). In an example, the latitude and longitude are concatenated into a single vector and/or the month and year are concatenated into a single vector, wherein the vectors are treated as the tokens. Different modalities (e.g., images, spatial coordinates, temporal state, etc.) can be tokenized with different precisions, different numbers of tokens, the same precision, the same number of tokens, and/or otherwise tokenized.

In variants, tokenizing the observations can additionally or alternatively include tokenizing each navigation sequence. A navigation sequence can be represented as a series of observation tokens, and can optionally include a start and end token to delineate the beginning and end of the navigation sequence. In an example, the start and end tokens can be analogous to <bos> and <eos> in language modeling. In an illustrative example, the navigation sequence (V) can be represented as {s_start, NI, . . . . Ni, . . . . Nn, s_end}, or be otherwise represented.

However, determining a training data set S100 may be otherwise performed.

Training the world model based on the training data set S200 functions to train a model that can predict: environmental measurements, a measurement's spatiotemporal state (e.g., location, orientation, measurement time), the next navigation action, and/or other information given a prompt.

The world model in S200 is preferably a transformer (e.g., LLAMA, 04, Claude, PaLM, etc.), but can additionally or alternatively be a diffusion model, GAN, DNN, CNN, RNN, and/or have any suitable architecture. The world model in S200 is preferably an autoregressive model, but can additionally or alternatively be a diffusion model, be trained using contrastive learning approaches, be trained using energy based models, be trained using reinforcement learning approaches, and/or otherwise trained. As one example, the transformer architecture has around 1 billion parameters following the LLaMA design, with an effective batch size of 1024. In this example, context length is 16K.

In examples, the world model can learn to predict the next observation in a navigation sequence conditioned on the previous observation(s), where each observation conditions the next in the sequence. In a first example, the world model can learn a conditional probability (e.g., P (Nt|Nt−1, Nt−2, NI), where Ni is an observation). In a second example, the world model can learn a set of mapping functions (e.g., function f, such that Nt=ƒ(Nt−1, Nt−2, . . . , Nt−k)+error). In a first example of the second example, the world model can learn a spatial-state function ƒss, which determines the spatial coordinates (lat, long) given an egocentric measurement (On) at step n. This can map the measurement to a set of precise geolocation coordinates. In a second example, the world model can learn a temporal-state function ƒts, which determines the temporal coordinates (month, year) given an egocentric measurement (On) and the spatial coordinates (latn, lonn) and step n. This can map the measurement and geographic location to a specific time, which can enable the model to understand environmental changes. In a third example, the world model can learn a spatial-action function ƒsa, which determines the spatial action (e.g., pose change, change along the direction of travel, change in x/y/z, change in orientation, change in distance (dn), change in heading (hn), etc.) given an egocentric measurement (On) and the spatial coordinates (latn, lonn) and step n. This can enable forward planning (e.g., identify the highest-probability next action from the given location, based on the measurement). In a fourth example, the world model can learn a temporal-action function ƒta, which determines the temporal action (e.g., change in month, change in year, etc.) given an egocentric measurement (On), the spatial coordinates (latn, lonn), and the spatial action (dn, hn) for step n. This can enable the model to learn how measurements for the same location change over time. In a fifth example, the world model can learn an observation-state-action function ƒo, which determines the next observation measurement given the measurement (On), the spatial coordinates (latn, lonn), the temporal state (month, year), the spatial change (dn, hn), and the temporal change (change month, change year). The state (e.g., spatial coordinates, temporal state, etc.) and the action (e.g., spatial change, temporal change, etc.) can be received from a user, predicted during a prior instance, and/or otherwise determined. This can enable high-fidelity measurement simulation of the next measurement frame. However, any other set of mapping functions can be learned.

The world model can be trained using regression, supervised learning, reinforcement learning, and/or otherwise trained.

In a first variant, training the world model based on the training data set S200 can include fitting a set of coefficients for the mapping functions to the navigation series.

In a second variant, training the world model based on the training data set S200 can include using next-token prediction. The world model can be trained using categorical cross-entropy loss, Mean Squared Error (MSE) loss, Hinge loss, Kullback-Leibler Divergence (KL Divergence) loss, and/or any other loss function. The world model can be trained using teacher forcing, a causal attention mask (e.g., to mask out future tokens in a navigation sequence), and/or any other training method. In a first example of the second variant, the world model can predict the next measurement (On+1) from the next observation, given an observation (On, Sn, etc.) and the action (An) separating the observation and the next observation in the navigation sequence, wherein the world model is updated based on a comparison between the predicted next measurement and the actual next measurement from the next observation. In variants, the next observation can be: used for secondary model training (e.g., perception model training, planner training, etc.), fed into a secondary model (e.g., a perception model, etc.), and/or otherwise used. In a second example of the second variant, the world model can predict the geographic coordinates for the observation given the measurement of the observation and optionally prior observations (e.g., measurements, geographic coordinates, etc.), wherein the world model is updated based on a comparison between the predicted and actual geographic coordinates. In variants, the geolocation of the ego vehicle can be predicted using the world model based on the observations, and periodically corrected based on a secondary geolocation measurement (e.g., GPS, dead reckoning off an IMU or encoder, etc.). Additionally or alternatively, the geolocation predicted by the world model can be used to correct drift in secondary geolocation methods (e.g., GPS drift, dead reckoning drift, etc.). In a third example of the second variant, the world model can predict the temporal state for the observation given the measurement of the observation, the geographic coordinates for the observation, and optionally prior observations (e.g., measurements, geographic coordinates, etc.), wherein the world model is updated based on a comparison between the predicted and actual temporal states. In a fourth example of the second variant, the world model can predict the next action within a navigational sequence given the measurement of the observation, the geographic coordinates for the observation, and optionally prior observations (e.g., measurements, geographic coordinates, actions, etc.), wherein the world model is updated based on a comparison between the predicted and actual next actions. In variants, the world model can supplant the planner in an autonomous vehicle, be used as a check on the planner's output, and/or be otherwise used.

However, training the world model based on the training data set S200 may be otherwise performed.

However, training a world model S10 may be otherwise performed.

Predicting outputs using the world model S20 functions to use the trained world model for inference.

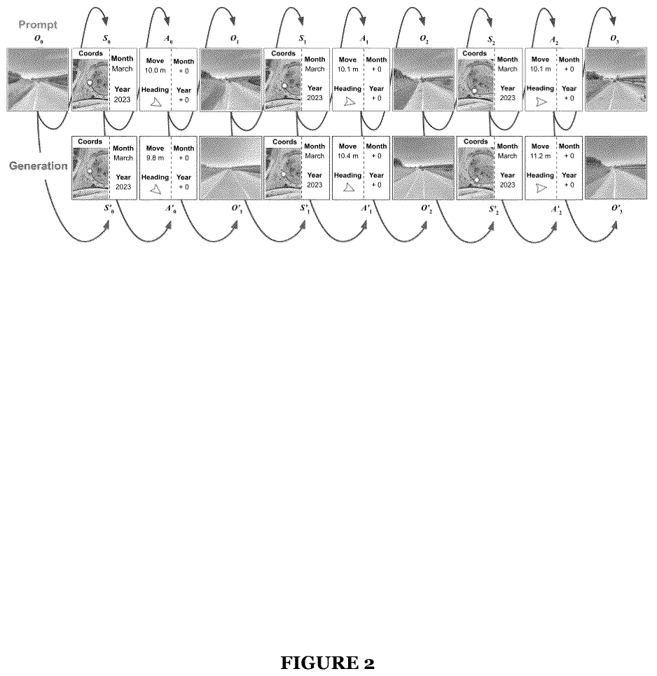

In variants, predicting outputs using the world model S20 includes receiving a prompt S300; and predicting a spatiotemporal response based on the prompt S400. S20 is preferably performed using the world model trained in S10, but can additionally or alternatively be performed using any other model. S20 can be performed: when a prompt is received, iteratively until a stop condition is met (e.g., predetermined number of rollouts have been met, the prediction deviating from a measured value by a threshold amount, etc.; example shown in FIG. 2), and/or at any other time.

Receiving a prompt S300 functions to receive a set of inputs to condition the world model. S300 can include one or more of various elements.

The prompt can include one or more of: an observation image, a geolocation, a temporal position (e.g., global time, relative time, etc.), spatial action (e.g., “move 10 m forward”), temporal action (e.g., “advance 6 months, stay in place”), and/or any other elements. The prompt can be received from: a user, a robotic control system (e.g., the planner, the behavior model, etc.), and/or otherwise received.

However, receiving a prompt S300 may be otherwise performed.

Predicting a spatiotemporal response based on the prompt S400 functions to predict a set of outputs, conditioned on the set of inputs and optionally on previously-predicted outputs (e.g., state, action, etc.) from a prior inference iteration. The spatiotemporal response is preferably conditioned on data within the prompt, but alternatively the prompt can lack a structured relationship with the output. In an example, the values of the prompt (e.g., conditioning input) can: constrain the candidate response values, be related to the candidate response values by a learned mapping function (e.g., ƒss, ƒts, ƒsa, ƒta, ƒo, etc.), influence the probability distribution of the response variable, and/or otherwise condition the candidate response.

In variants, the model can iteratively predict subsequent sets of outputs based on the prior results.

In a first example, the world model can generate all potential outputs (e.g., measurement, state, action, next observation) based on an initial observation image. The model can predict the current spatial coordinates (e.g., latitude/longitude) based on the initial observation image; predict the current temporal position (e.g., month/year) based on the initial observation image and the current spatial coordinates; predict the next spatial action (e.g., change in distance, change heading, etc.) based on the initial observation image and current spatiotemporal state; predict the next temporal action (e.g., change in time) based on the initial observation image, the current spatiotemporal state, and the next spatial action; and predict the next observation (e.g., generate an image) based on the initial observation image, the current spatiotemporal state, and the next action (e.g., spatiotemporal change). The world model can repeat the process using the predicted next observation, and continue rolling out the simulation until a stop condition is met (e.g., predetermined number of iterations, etc.).

In a second example, the world model can be used to geolocate an observation based on an input observation image. The world model can predict the geolocation (e.g., latitude/longitude) of the observation.

In a third example, the world model can simulate navigation (e.g., simulate the next frame given a spatial change) given an initial observation image and a spatiotemporal action (e.g., “move 10 meters forward, heading 45°, no time change”). The world model can predict the geolocation, optionally predict the time, then predict the next measurement given the initial observation image, the predicted geolocation, the predicted time, and the spatiotemporal action. The spatiotemporal action can be received from the user, be received from an autonomous driving system (e.g., a planner), be predicted by the world model, and/or be otherwise determined.

In a fourth example, the world model can explore temporal changes in a given geographic location based on an observation image and a temporal action (e.g., “stay in place, advance 6 months”). The world model can predict the geolocation, optionally predict the time of the observation image, then predict the time-shifted measurement (e.g., what the same location would look like after that time period) given the initial observation image, the predicted geolocation, and the temporal action. The temporal action can be received from the user, be received from a simulation orchestration system, and/or be otherwise determined.

In a fifth example, the world model can provide controlled navigation (e.g., generate control instructions for the next timestep based on the input), given an observation image. The world model can predict the geolocation, optionally predict the time, then predict the next action (e.g., distance, heading, etc.) given the initial observation image and the predicted geolocation.

However, predicting a spatiotemporal response based on the prompt S400 may be otherwise performed.

However, predicting outputs using the world model S20 may be otherwise performed.

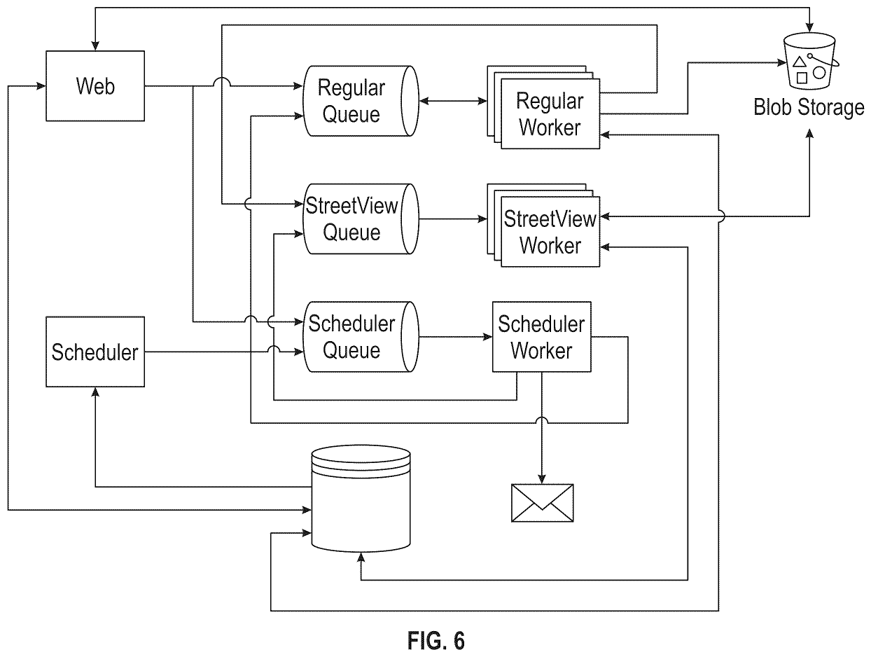

FIG. 6 illustrates a general overview of an architecture for a spatiotemporal scrapper for scraping image data (e.g., for generating a training data set for use with embodiments of the present disclosure). Here shown is a Django and Celery application deployed on Kubernetes, where each worker is independently scaled to accommodate the desired throughput for Google StreetView image scraping through the use of message brokers and queues. Decoupling metadata from image data permits gathering insights about the data without needing to pull the images each time.

FIG. 12 illustrates an exemplary hardware architecture used for implementing the methods according to an embodiment of the disclosure. The exemplary hardware architecture 1200 includes one or more processors 1210 in electrical communication with one or more local memory elements 1220, and optionally one or more image data repositories 1230. In some embodiments, images present within a reference data set are retrieved from the one or more image data repositories 1230 and loaded into the one or more local memory elements 1220 (e.g., for use in training a world model implemented by the one or more processors 1210). In some embodiments, the one or more local memory elements 1220 store the embedded image data of the reference data set. Optionally, in some embodiments, the one or more processors 1210 is in electrical communication with one or more control elements 1240 (e.g., for connecting to an action model and controlling one or more motors, actuators, or otherwise for controlling and/or directing an autonomous device).

In some embodiments, hardware architecture 1200 is an architecture of an electronic device or a computing system configured to operate and/or control an autonomous vehicle or device.

In some embodiments, the one or more local memory elements 1220 and the one or more processors 1210 are implemented on a same computer system 1250. In some embodiments, the one or more control elements are implemented on the same computer system 1250. In some embodiments, the processor is in electrical communication with the one or more local memory elements 1220, the one or more image data repositories 1230, and/or the one or more control elements over a wired or wireless communication link. In some embodiments, the wired communication link includes USB, Ethernet, RS232 or any other comparable communication standard. In some embodiments, the wireless communication link includes WiFi, Bluetooth, Zigbee or any other comparable communication standard.

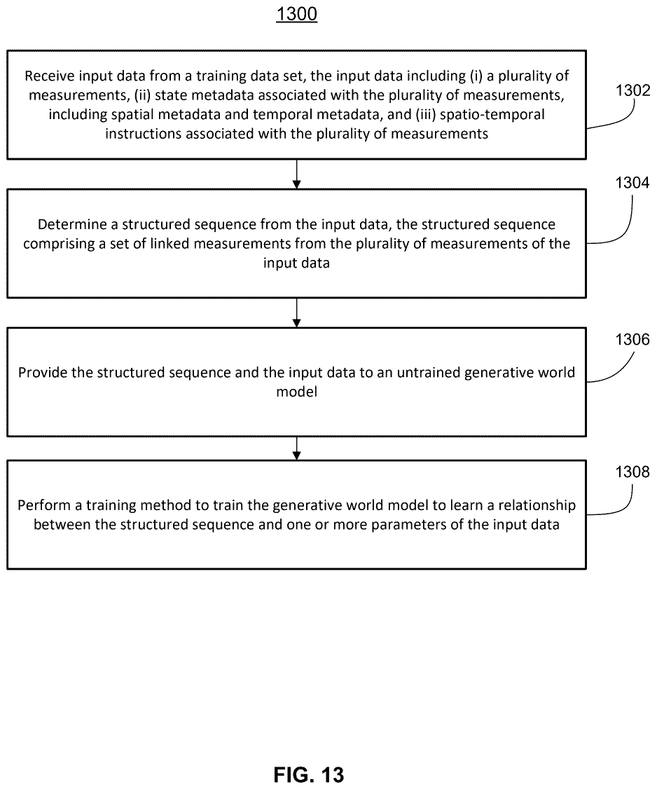

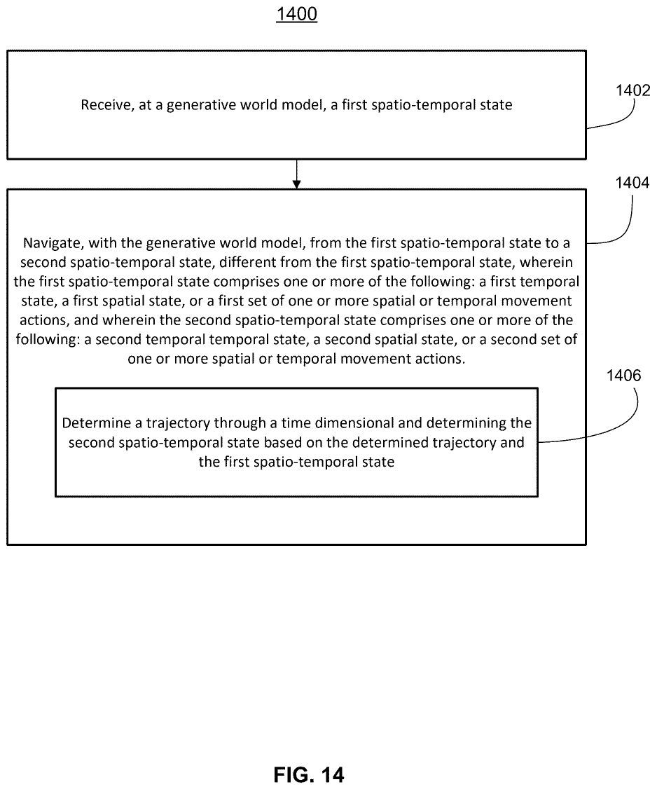

In some embodiments, the processor is configured to execute instructions stored on a non-transitory computer-readable medium (e.g., instructions stored in the one or more local memory elements 1720). In some embodiments, the executing the instructions enables a computing device (e.g., a computing device of an autonomous vehicle) to provide the steps of the methods shown in FIGS. 13 and 14, described below.

FIG. 13 is a flowchart depicting an exemplary method for training a world model that models time as a navigable dimension for spatio-temporal prediction, according to the disclosure. Method 1300 comprises steps 1302 through 1308. Step 1302 includes receiving input data from a training data set, the input data including (i) a plurality of measurements, (ii) state metadata associated with the plurality of measurements, including spatial metadata and temporal metadata, and (iii) spatio-temporal instructions associated with the plurality of measurements. Step 1304 includes determining a structured sequence from the input data, the structured sequence comprising a set of linked measurements from the plurality of measurements of the input data. Step 1306 includes providing the structured sequence and the input data to an untrained generative world model. Step 1308 includes performing a training method to train the generative world model to learn a relationship between the structured sequence and one or more parameters of the input data.

FIG. 14 is a flowchart depicting an exemplary method for determining, with a generative world model that models time as a navigable dimension for spatio-temporal prediction, a second spatio-temporal state from a first spatio-temporal state, according to the disclosure. Method 1400 comprises steps 1402 through 1406. Step 1402 includes receiving, at the generative world model, the first spatio-temporal state. Step 1404 includes navigating from the first spatio-temporal state to the second spatio-temporal state, different from the first spatio-temporal state, wherein the first spatio-temporal state comprises one or more of the following: a first temporal state, a first spatial state, or a first set of one or more spatial or temporal movement actions; and the second spatio-temporal state comprises one or more of the following: a second temporal state, a second spatial state, or a second set of one or more spatial or temporal movement actions. As set out in Step 1406, navigating from the first spatio-temporal state to the second spatio-temporal state includes determining a trajectory through a time dimension and determining the second spatio-temporal state based on the determined trajectory and the first spatio-temporal state.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken lines in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system (e.g., processor 1210 shown in FIG. 12) to perform the method(s) discussed herein. The instructions can be executed by computer-executable components integrated with the computer-readable medium and/or processing system. The computer-readable medium may include any suitable computer readable media (e.g., local memory 1220 shown in FIG. 12) such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors, such as processor 1210 shown in FIG. 12) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

In some embodiments, there is provided a generative world model that models time as a navigable dimension for spatio-temporal prediction. The generative world model is configured to: receive a first spatio-temporal state, and navigate from the first spatio-temporal state to a second spatio-temporal state, different from the first spatio-temporal state, such as is illustrated in FIG. 2 and FIG. 3. In some embodiments, navigating from the first spatio-temporal state to the second spatio-temporal state includes determining a trajectory through a time dimension and determining the second spatio-temporal state based on the determined trajectory and the first spatio-temporal state, the first spatio-temporal state comprises one or more of the following: a first temporal state (e.g., a month, year, day, hour, and/or minute), a first spatial state (e.g., an x-y or x-y-z coordinate, a latitude, or a longitude), or a first set of one or more spatial or temporal movement actions (a change in time such as Δmonth or Δyear, or a change in spatial location); and the second spatio-temporal state comprises one or more of the following: a second temporal state (e.g., a month, year, day, hour, and/or minute), a second spatial state (e.g., an x-y or x-y-z coordinate, a latitude, or a longitude), or a second set of one or more spatial or temporal movement actions (a change in time such as Δmonth or Δyear, or a change in spatial location), such as is illustrated in FIG. 2. In some examples, a set of one or more spatial or temporal movement actions includes a textual description of the action received by the world model (e.g., “move forward 5 m”).

As one example, the world model is a model that can learn and understand dynamics of the real world, including physics and spatial properties. As a result, the world model can learn a plurality of relationships between temporal states, spatial states, and/or movement actions. For example, given a certain temporal state and spatial state, the world model can receive a spatial and or temporal movement action (e.g., move forward 9.0 m or move forward in time by 10 seconds), and can generate a new temporal state and/or spatial state. Such a world model allows for improved prediction of future states, which is advantageous, e.g., with autonomous vehicles and predicting new states for movement.

In some embodiments, the first spatio-temporal state includes: one or more of the first temporal state and the first spatial state; and the first set of one or more spatial or temporal movement actions.

In some embodiments, navigating from the first spatio-temporal state to a second spatio-temporal state includes applying one or more mapping functions to the first spatio-temporal state. As an example, the mapping functions include learned relationships between the first spatio-temporal state and the output of the world model. In some examples, the mapping functions include one or more of the prediction formulas (1)-(4) described in the technical overview above.

In some embodiments, the one or more mapping functions include one or more of the following: a spatial state to spatial state function (e.g., (x,y) to (x′, y′)), a temporal state to temporal state function (e.g., t to t′), a movement action to movement action function, a spatial state to temporal state function (e.g., (x,y) to t′), a spatial state to movement action function, a temporal state to movement action function, a spatial-temporal state to spatial-temporal state function (e.g., (x, y, t) to (x′, y′, t′), or a spatial-temporal state to movement action function.

In some embodiments, the first spatial state comprises one or more spatio-temporal coordinates (e.g., (x, y, t)) determined at least partially from sensor data acquired at a first time. In some examples, the spatial state is derived from image data received synchronously with the processing of the spatial state.

In some embodiments, the sensor data comprises an image acquired via an image sensor.

In some embodiments, the spatio-temporal coordinates comprise one or more spatial coordinates (e.g., (x, y)) and one or more temporal coordinates (e.g., t), wherein the one or more spatial coordinates are determined from the sensor data, and wherein the one or more temporal coordinates are acquired from the sensor data and the one or more spatial coordinates.

In some embodiments, the first set of spatial or temporal movement actions are determined based on the one or more spatio-temporal coordinates and the sensor data.

In some embodiments, the first set of one or more spatial or temporal movement actions comprises one or more instructions for changing a spatial state or a temporal state.

In some embodiments, there is provided a method of training a generative world model that models time as a navigable dimension for spatio-temporal prediction, such as is illustrate by step S10 in FIG. 1 and FIG. 13. The method comprises: receiving input data, from a training data set, wherein the input data includes: (i) a plurality of measurements, (ii) state metadata associated with the plurality of measurements, the state metadata including spatial metadata and temporal metadata, and (iii) spatio-temporal instructions associated with the plurality of measurements; determining a structured sequence from the input data, the structured sequence comprising a set of linked measurements from the plurality of measurements of the input data; providing the structured sequence and the input data to an untrained generative world model; and performing a training method to train the generative world model to learn a relationship between the structured sequence and one or more parameters of the input data.

In some embodiments, the generative world model comprises an autoregressive model.

In some embodiments, the plurality of measurements includes sensor data acquired from a sensor, the sensor data including one or more of the following: image data, depth data, or acoustic data, such as is illustrated by the image data shown in FIGS. 2-5.

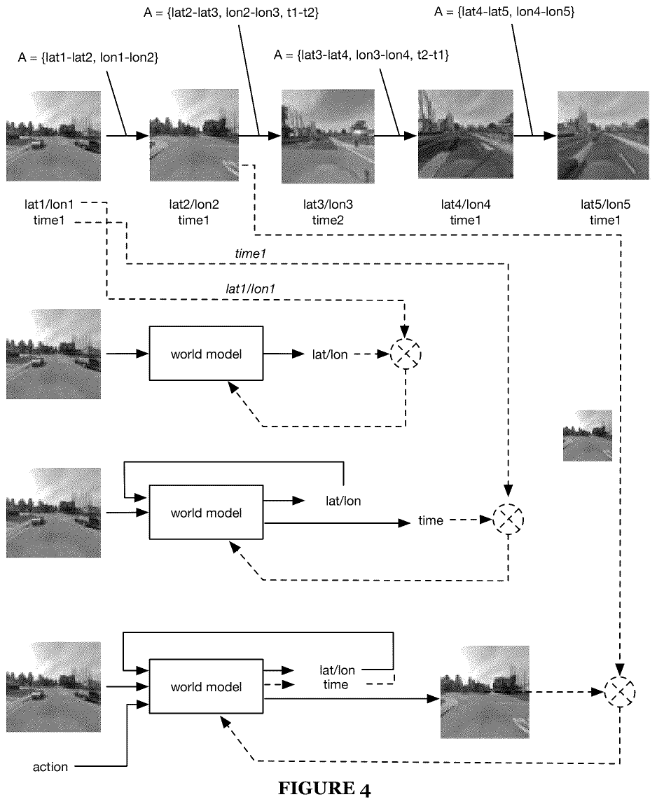

In some embodiments, the spatial metadata includes one or more of the following for each respective measurement: a current location, a heading, a pitch, a roll, a latitude, or a longitude, and wherein the temporal metadata includes a current time of the respective measurement, such as is illustrated by FIG. 4.

In some embodiments, determining the structured sequence from the input data comprises linking adjacent measurements of the plurality of measurements based on the state metadata of the respective measurements and based on a compliance with one or more requirements of a first ruleset, such is illustrated by FIG. 3.

In some embodiments, the first ruleset comprises a set of allowable movements based on an environment associated with the plurality of measurements, as illustrated by FIG. 3.

In some embodiments, the set of allowable movements is determined from the plurality of measurements.

In some embodiments, there is provided a method of determining, with a generative world model that models time as a navigable dimension for spatio-temporal prediction, a second spatio-temporal state from a first spatio-temporal state, such as is illustrated by S20 in FIG. 1 and FIG. 14. The method comprising: receiving the first spatio-temporal state, and navigating from the first spatio-temporal state to a second spatio-temporal state, different from the first spatio-temporal state, wherein: navigating from the first spatio-temporal state to the second spatio-temporal state includes determining a trajectory through a time dimension and determining the second spatio-temporal state based on the determined trajectory and the first spatio-temporal state, the first spatio-temporal state comprises one or more of the following: a first temporal state, a first spatial state, or a first set of one or more spatial or temporal movement actions; and the second spatio-temporal state comprises one or more of the following: a second temporal state, a second spatial state, or a second set of one or more spatial or temporal movement actions, such as is illustrated in FIG. 2.

In some embodiments, the second spatio-temporal state includes the second set of one or more spatial or temporal movement actions, and wherein the method further comprises: providing the one or more spatial or temporal movement actions as an instruction to a control mechanism of a device (e.g., an actuator of an autonomous vehicle, such as an actuator for controlling wheel movement).

In some embodiments, there is provided a non-transitory computer readable storage medium (e.g., local memory 1220 shown in FIG. 12) storing one or more programs, the one or more programs comprising instructions, which when executed by one or more processors (e.g., processor 1210 shown in FIG. 12) of an electronic device (e.g., a computing device of an autonomous vehicle, or a computing system), cause the electronic device to: receive input data, from a training data set. In some embodiments, the programs include executable code stored on processor 1210 shown in FIG. 12.

In some embodiments, the input data includes: (i) a plurality of measurements, (ii) state metadata associated with the plurality of measurements, the state metadata including spatial metadata and temporal metadata, and (iii) spatio-temporal instructions associated with the plurality of measurements; determine a structured sequence from the input data, the structured sequence comprising a set of linked measurements from the plurality of measurements of the input data; provide the structured sequence and the input data to an untrained generative world model; and perform a training method to train a generative world model to learn a relationship between the structured sequence and one or more parameters of the input data.

In some embodiments, the generative world model comprises an autoregressive model.

In some embodiments, the plurality of measurements includes sensor data acquired from a sensor, the sensor data including one or more of the following: image data, depth data, or acoustic data.

In some embodiments, the spatial metadata includes one or more of the following for each respective measurement: a current location, a heading, a pitch, a roll, a latitude, or a longitude, and wherein the temporal metadata includes a current time of the respective measurement.

In some embodiments, determining the structured sequence from the input data comprises linking adjacent measurements of the plurality of measurements based on the state metadata of the respective measurements and based on a compliance with one or more requirements of a first ruleset.

In some embodiments, the first ruleset comprises a set of allowable movements based on an environment associated with the plurality of measurements.

In some embodiments, the set of allowable movements is determined from the plurality of measurements.

In some embodiments, there is provided an non-transitory computer readable storage medium (e.g., local memory 1220 shown in FIG. 12) storing one or more programs (e.g., executable code stored on processor 1210 shown in FIG. 12), the one or more programs comprising instructions, which when executed by one or more processors (e.g., processor 1210 shown in FIG. 12) of an electronic device (e.g., a computing device of an autonomous vehicle, or a computing system), cause the electronic device to: receive a first spatio-temporal state, and navigate from the first spatio-temporal state to a second spatio-temporal state, different from the first spatio-temporal state, wherein: navigating from the first spatio-temporal state to the second spatio-temporal state includes determining a trajectory through a time dimension and determining the second spatio-temporal state based on the determined trajectory and the first spatio-temporal state, the first spatio-temporal state comprises one or more of the following: a first temporal state, a first spatial state, or a first set of one or more spatial or temporal movement actions; and the second spatio-temporal state comprises one or more of the following: a second temporal state, a second spatial state, or a second set of one or more spatial or temporal movement actions.

In some embodiments, the second spatio-temporal state includes the second set of one or more spatial or temporal movement actions, and wherein the one or more programs further comprise instructions for: providing the one or more spatial or temporal movement actions as an instruction to a control mechanism of a device (e.g., an actuator of an autonomous vehicle, such as an actuator for controlling wheel movement).

In some embodiments, there is provided a vehicle (e.g., an autonomous vehicle) comprising one or more processors and a non-transitory computer readable medium storage medium storing one or more programs comprising instructions, wherein the one or more processors are configured to execute the instructions for performing one or more actions associated with the vehicle (e.g., actions associated with the above-described embodiments of the non-transitory computer-readable storage mediums).

### Exemplary Training Data for World Model

To allow the model to learn from the intricacies and nuances of the navigable world, the training data can be imbued with multiple modalities of observations that precisely describe it and/or approximate it in the digital sense: images, spatial coordinates and temporal coordinates.

There may also be provided instructions in the form of additional tokens that encode movement in both the physical and temporal sense. As a first approximation for a spatiotemporal navigation setup, the navigable world can be represented as a series of actions an autonomous vehicle would take. This decision allows for free exploitation of available data from Google StreetView along with open-source OpenStreetMap road data to encode the “permissible steps” that the model is allowed to take.

“Permissible steps” are defined by steps that the model is allowed to take as actions which fall within a legally drivable road segment (driveways, highways, parking lots, etc). Multi-node navigational data is created by running a DFS algorithm from each node (described in detail in the following sections), projecting views in the direction of travel and calculating states and actions along the DFS path.

Furthermore, the model is permitted to perform the equivalent of “taking a look” of its surroundings to maximize its exposure to the environment; this is done by projecting the aforementioned panoramic images into multiple directions and encoding it as an additional “lookaround” action. That is, single-node “lookaround” data is generated to increase visual coverage of the surroundings and maximize exposure to the environment; this is done by projecting the aforementioned panoramic images into four 90° directions which fully captures the surroundings, this is accompanied by appropriate heading change actions.

The final form of the present training data is represented as a series of tokens that represent an array of “observations”. The final form of each of a navigational sequence Vis represented as a series of tokens that represent an array of samples at a point in space time (e.g., a point in spatial-time as an image, spatial coordinates, temporal coordinates, and the next instructions) as follows: V={Tₛₜₐᵣₜ, O₁, . . . , Oᵢ, . . . , Oₙ, T_{end}}.

Here Tₛₜₐᵣₜ and T_{end} are the start and end sequence tokens respectively, analogous to <bos> and <eos> in language modeling. Each sample Oᵢ is the i-th observation that the model took from its navigable universe, along with the actions necessary to go to the next observation Oᵢ₊₁, represented too as a set of tokens: Oᵢ={Tₗ, Tₗₐₜ, Tₘₒₙₜₕ, T_{year}, Tₘₒᵥₑ, T_{bearing}, T_{Δmonth}, T_{Δyear}}. In this example, each sample Oᵢ represents a set of tokens that encode an image (i=1024), spatial coordinates (i=2), temporal coordinates (i=2), and the “next action” (i=4) with the appropriate start and end tokens between to support multi-modal generation.

Here, there is the distinction between “descriptive tokens” and “instruction tokens”, where one describes the spatiotemporal snapshot of the observable universe, while the other describes where to go next both in the physical and temporal axes. As expected, Tris the set of tokens representing the image, Tₗₐₜ the latitude, Tₗₒₙ the longitude, Tₘₒₙₜₕ the month and T_{year} the year, which are all the “descriptive tokens”. On the other hand, the “instruction tokens” are Tₘₒᵥₑ, T_{bearing}, T_{Δmonth}, and T_{Δyear}.

The images and metadata used for this experiment were taken from open-source 360° Google StreetView (GSV) imagery. The data source was chosen because of the sheer volume of scrappable images they possess, coupled with high-fidelity and inertially-corrected accurate metadata. What's more, due to the nature of panoramic images such as these, it is possible to project them in a configurable number of directions, essentially increasing the effective number of data points samples from which a model could learn. As one example, this can increase the effective number of samples by a factor greater than 27. The average size of each panoramic image is around 10.0±2.8 MB, and their resolutions fell into (16,384×8,192), (13,312×6,656) or (3,328×1,664), all with an aspect ratio of 2:1. The metadata fields obtained from GSV included, but were not limited to: year, month, heading, pitch, roll, latitude, and longitude.

For ease of management, some extra metadata can also be computed to aid in deduplication efforts, as well as additional analyses: width, height, MD5 hash, and size in bytes (after converting to JPEG). The average size of each panoramic image was around 10.0±2.8 MB, and their resolutions fell into (16,384×8,192), (13,312×6,656) or (3,328×1,664), all with an aspect ratio of 2:1. Due to limitations of the memory-leaky image scraping code, as well as its scale, a GeoDjango/Celery application that was deployed on a Kubernetes cluster was developed, where a configurable amount of Celery workers are scaled according to the desired throughput (e.g., done manually). The images were uploaded to a blob store, separately from the metadata which was stored in a PostGIS instance with the appropriate geospatial indices. This architecture managed to scrape millions of images for internal use and testing, but for the actual training/validation data, considerably less images can be used.

One key aspect of the GSV modality is the way it naturally resembles a network of interconnected nodes, where each node in the graph is a snapshot of the surroundings in a particular point in time and space. This orderliness also happens to encode ‘permissible steps’ that a sequential model such as ours would be able to take to remain in a valid spatiotemporal consistent state, implicitly learning the physics of movement to some extent.

An additional benefit from arranging GSV data into a graph is that it can be permuted in any amount of ways, which translates to a non-trivial combinatorial amount of “visual sentences” that can be fed into the model as training data. The present graphs may be limited to undirected, unweighted graphs to maximize the number of actions allowed to the model (i.e. the action A→B is distinctly different from B→A), but this also means the model doesn't concern itself with traffic rules and regulations. This allows the model to learn a complete state-space representation of the real world.

To permute the graph, a slightly modified version of iterative DFS can be used, where DFS is performed on each node until a maximum number of paths for that node is reached or until the maximum number of nodes/samples per sentence (both configurable parameters) is hit, whichever comes first. This was done to control the amount of compute and time spent on generating the training data.

As an example, shown in Table 2, STRIDE comprises of approximately 82B tokens which were arranged into a total of 6 M visual “sentences” or token sequences. The sequences are generated from a relatively small set of 131 k panoramic images, along with their metadata and openly available highway system data. This approach enables a 27× increase in information, allowing for generative world model training. An exemplary complete breakdown of the dataset statistics is shown on Table 2.

TABLE 2
Exemplary Stride Dataset

| | | | | Projected |
|---|---|---|---|---|
| | Tokens | Sequences | Panoramas | Images |
| Training | 80B | 5.9M | 105k | 2.9M |
| Validation | 2B | 393k | 26k | 718k |
| Total | 82B | 6.3M | 130k | 3.6M |

Note: starting with relatively few panoramic images (131 k) still produces a sizable dataset (3.6 M) of uniquely projected visual data, all following navigational path sequences.

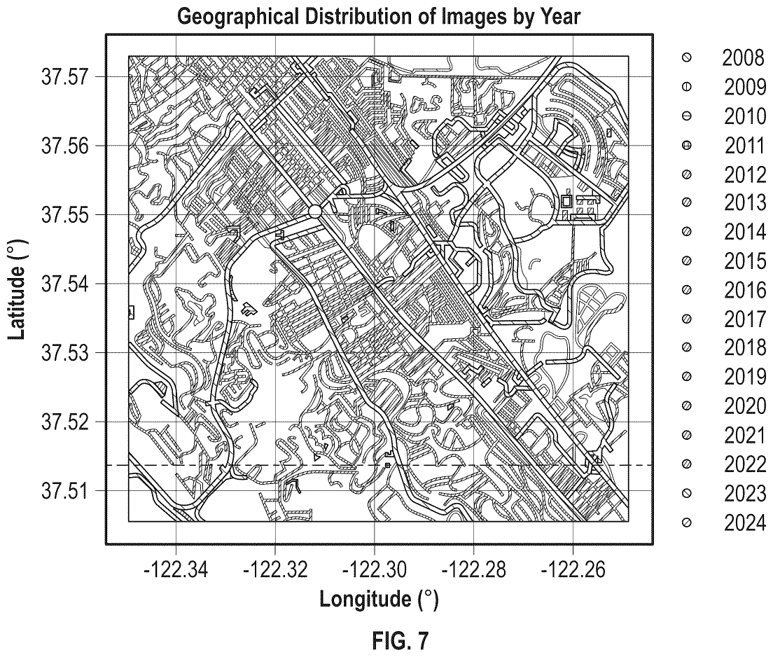

FIG. 7 illustrates an exemplary geographical distribution of streetview data within a bounding box, for use with a generative world model according to embodiments of the disclosure. As shown, there is defined an approximately 9.2 km wide by 7.5 km high bounding box of San Mateo City, from 134,702 panoramic images are pulled. Afterwards, using OpenStreetMap (OSM) data, the road network of the same area is reconstructed in order to leverage its spatial consistency for the data. All OSM “highway types” that fell into the category of “footway”, “cycleway”, “path”, “track”, “steps”, “corridor”, “pedestrian”, “via ferrata” or “ladder” are excluded, to only be left with what is interpreted to be valid “driveways”. After applying a GSV network algorithm, the result is a graph of interconnected GSV nodes (e.g., 130 k interconnected GSV nodes) that can be used to generate any permutation of ‘permissible actions’ within the context of a bounded area.

A noticeable limitation of a GSV network-reconstruction algorithm is the fact that it can't distinguish between nodes that should be close in 2D space (i.e. latitude and longitude) but far away in 3D space due to height changes (i.e. over-passes). This leads to physically improbable actions being included in the training data, which implicitly tells the model they are valid actions when they shouldn't be.

Other considerations to assuming OSM as a ground truth for road network data: (1) OSM data only contains the most up-to-date roads at the time of pulling, but GSV yields data across multiple points in time, so decommissioned roads where GSV points might've lied were not picked up; and (2) GSV coordinates might lie outside of what should be a road according to OSM, and so GSV data is left out as well.

To complement the rich graph data, “lookaround data” is added, which is the equivalent of having the model learn how its surroundings look like by having it “turn around” 360° on a static point in both time and space, which maximizes the model's exposure to its environment. This included projecting each image inside the graph in 4 steps of 90° each. This yields (360/90)!=24 permutations of the same, all with the same metadata and a static translation instruction (i.e. “move 0 meters”) but with a nonzero look-around instruction.

### Results

### Controllable Image Generation:

Generating photorealistic images in a physically controllable way is an under-explored task. Existing generative models either output a single image given a text description or attempt to understand commanded change via analogy prompting. TARDIS is grounded on real-world data, states and instructions, leading to controllable image generation.

TARDIS is prompted with spatio-temporally held-out validation ground-truth states and instructions in order to compare newly generated images against expected real-image results. To qualitatively compare against the recent Chameleon-7B, another naively multi-modal architecture trained to follow textual instructions. Chameleon uses a similar (although bigger) transformer architecture as well as the same image tokenizer. To identify if STRIDE has enabled the model to understand physical space to a higher degree than general-purpose models, Chameleon is prompted with the textual instruction equivalent of a state-action paradigm along with the same image observations. FIG. 8 shows the difficulty in control and consistency issues of Chameleon in comparison with TARDIS. Further qualitative results can be found on FIG. 4.

Quality can be measured quantitatively via the perplexity metric. Note that visual metrics have often been found to not necessarily be representative of image quality. However, perplexity can be measured as a function of spatial and temporal commands. It can be found that along the breadth of temporal coverage in the validation data the perplexity trend remains mostly stable FIG. 18. Further, while movement actions does have a large spread of error, the overall trend is again mostly consistent with a drop around 10 m, this is likely because the majority of spatial distances in the data falls near the 10 m range FIG. 19. Finally, it can be observed that for the majority of temporal actions both in month and year perplexity remains largely consistent with spokes at the edges (−15, +13) of the year temporal actions present in the validation data FIG. 20. This, along with the visual results suggests the model is reliably following the generative instructions given to it during evaluation.

In variants, the model can instruction follow.

The fidelity of predicted images and states given a controlled action can be measured and it can be observed that the model produces outputs that closely follow the intended instructed path.

### Georeferencing:

Georeferencing is the task of returning the geo location of a given input image. It is common to return the global latitude and longitude coordinates if the task is absolute positioning.

TARDIS is able to output coordinate tokens which correspond to global coordinates within its 9.2×7.5 km training and evaluation area.

TARDIS is prompted with 1 . . . n validation nodes and measure its real-world meter error compared to the real coordinate. Since TARDIS is able to input spatial commands which relate to the following spatial location, self-masking of tokens which fall outside the expected radius defined by the move command is dynamically allowed. This allows the model reliably predict coordinate tokens physically outside the spatial distribution it was trained on, in other words, predict tokens within the unseen validation area.

These results can be compared against a leading method (SVG) which leverages a contrastive method for ground-image to aerial map similarity measurements. Similar to TARDIS this method was not trained on the validation area for which performance is measured and TARDIS does not input the aerial images the baseline method requires.

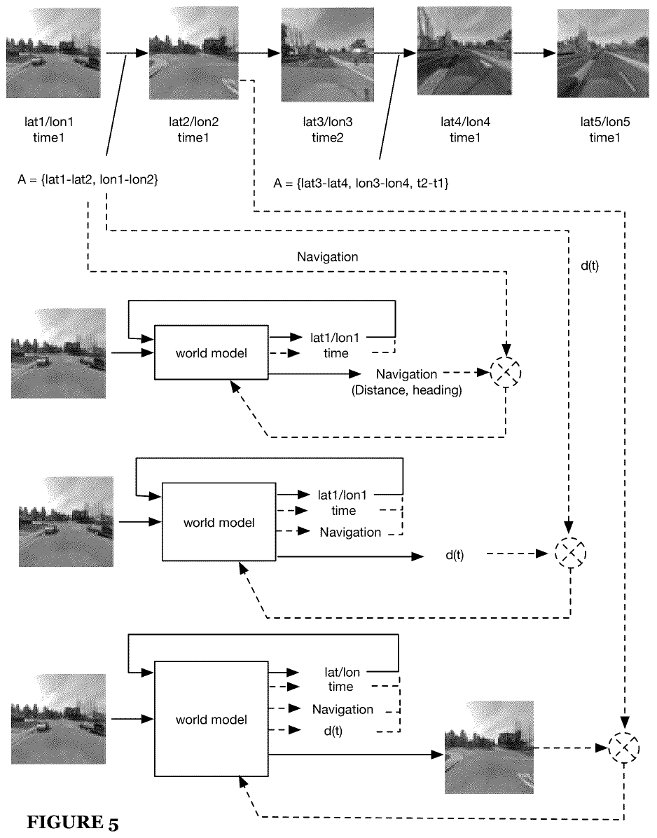

It is noted that TARDIS does not suffer as heavily from a base-map to ground-map temporal difference compared to alternate methods. This previous method is described here: Statewide Visual Geolocalization (SVG) SVG is a model which is able to predict the location of a street-view photo by matching it on a database of aerial reference imagery. The model is trained on mapping data between street and aerial data on two US states, and four German states, and uses a ConvNeXt backbone alongside attention-based pooling to generate an embedding vector for the street and aerial regions. Cosine similarity between the query point and a reference database location is then used to geolocate the query image. In FIG. 15, the results of a CDF on the geolocation error of the two methods is demonstrated, on both the entire temporally held-out dataset and the spatiotemporally held-out area data. According to the CDF plot in FIG. 15 TARDIS achieves 60% of predictions within 10 m while SVG does not reach 10% at the same metric. Further SVG's “search space” is restricted to that of only 50 m around the true location of the camera, this is to match TARDIS maximum move action of 50 meters. However, as seen on FIG. 5 a large performance advantage, is still observed.

### Self Control Quality:

The probability distribution of heading tokens when the model is traversing the physical space autonomously is measure (by allowing the model to generate its own distance and heading instructions given real validation data on fully held-out areas spatiotemporally). The intention is to observe whether or not, for an unvisited region, the model is able to understand its surroundings given real visual observation inputs. This is measured quantitatively by calculating the percent of actions which produce a following state within some distance threshold of the nearest road center line.

It is observed that the model insists on providing itself action inputs which remain on the road, following curves and choosing directions when at an intersection.

Given an average lane length in the USA of 12 ft (3.7 m), TARDIS generated actions fall within the road 77.4% of the time on unseen validation environments. After filtering out trivial static actions (move=0), the valid action percentage remains above 70%. To avoid cherry-picking an optimal lane length that would maximize the model's success rate, results for lane-lengths in increments of 1 m, up to 10 m is calculated.

To ensure the model is not taking very small steps in order to stay within bounds FIG. 17 shows that 60% of the time TARDIS generates steps of 5 m or greater, which is wider than many residential roads. For qualitative analysis heading (arrowhead) and distance (line length) are plotted on a satellite map of the spatiotemporally held-out area, shown in FIG. 7. The observations show the majority of the actions fall within the road network, with lane and curve following. Sometimes the generated action take the next state into a driveway which is not a behavior present in the GSV or STRIDE dataset, but could be an emergent property.

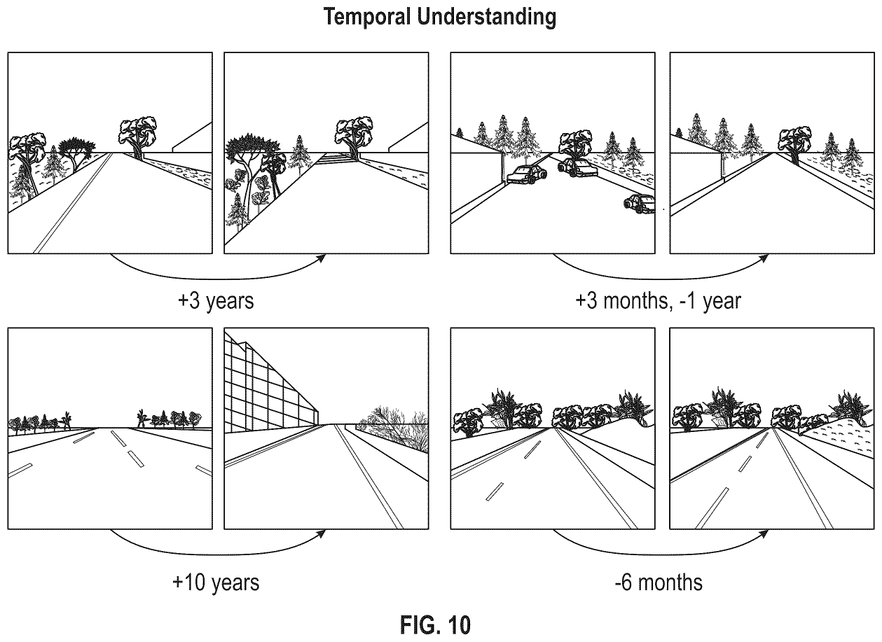

As illustrated by FIG. 10, the world model intuitively understands changes in a time (e.g., change in season). As illustrated are four prompt images and four generated output images given a manual temporal instruction (e.g., +3 years). The top right example moves from Autumn (September 2014) to Winter (December 2013). Bottom right action moves 6 months in order to change seasons. In order to measure the models understanding of purely temporal commands it is prompted to change seasonality and observe if transient objects have disappeared and if the sea-sons have observably changed (such as the trees turning yellow and losing leaves).

TARDIS is prompted with instruction that leads generation into areas where no data is recorded both spatially and temporally.

Synthetic imagery: It can be observed for these previously unknown datapoints is reasonably what could be expected the real-world to be depicted as.

An exemplary self-control quality table for different lane widths using the current STRIDE dataset is provided below in Table 3.

TABLE 3
Exemplary Self-Control Quality for Lane Widths

| Lane Length (m) | Valid (All Actions) % | Valid (Nonzero Move) % |
|---|---|---|
| 1.0 | 55.0 | 42.4 |
| 2.0 | 66.8 | 56.3 |
| 3.0 | 72.8 | 64.2 |
| 4.0 | 77.4 | 70.5 |
| 5.0 | 81.4 | 75.8 |
| 6.0 | 85.0 | 80.6 |
| 7.0 | 88.0 | 84.6 |
| 8.0 | 90.6 | 88.0 |
| 10.0 | 94.9 | 93.8 |

### Sense of Time:

In order to measure the models understanding of temporal dynamics a static spatial move along with large temporal change is manually prompted on spatiotemporally held-out validation data. The objective is to advance time enough to observe seasonal change, observe if transient objects have disappeared, or other large changes while simultaneously the generated image remains largely consistent. Some examples of this property are provided in FIG. 10, advancing from Fall to Winter does appear to affect the foliage (right columns) while larger time skips may also impact the infrastructure with degrading roads or new developments appearing (left columns).

Further data and results, including qualitative TARDIS samples, GSV data temporal distribution for training/testing, TARDIS self-control action magnitude CDF, average error per year of TARDIS vs. SVG, perplexity vs . . . year-month dates, perplexity vs. testing action move, perplexity over GT temporal action year and month are provided in U.S. Provisional Application No. 63/860,539, filed Aug. 8, 2025, the contents of which are incorporated herein by reference in its entirety for all purposes.

We claim:

1. A generative world model that models time as a navigable dimension for spatio-temporal prediction, the generative world model configured to:
receive a first spatio-temporal state, and
navigate from the first spatio-temporal state to a second spatio-temporal state, different from the first spatio-temporal state, wherein:
navigating from the first spatio-temporal state to the second spatio-temporal state includes determining a trajectory through a time dimension and determining the second spatio-temporal state based on the determined trajectory and the first spatio-temporal state,
the first spatio-temporal state comprises one or more of the following: a first temporal state, a first spatial state, or a first set of one or more spatial or temporal movement actions; and
the second spatio-temporal state comprises one or more of the following: a second temporal state, a second spatial state, or a second set of one or more spatial or temporal movement actions.

2. The generative world model of claim 1, wherein the first spatio-temporal state includes:
one or more of the first temporal state and the first spatial state; and
the first set of one or more spatial or temporal movement actions.

3. The generative world model of claim 1, wherein navigating from the first spatio-temporal state to a second spatio-temporal state includes applying one or more mapping functions to the first spatio-temporal state.

4. The generative world model of claim 3, wherein the one or more mapping functions include one or more of the following:
a spatial state to spatial state function,
a temporal state to temporal state function,
a movement action to movement action function,
a spatial state to temporal state function,
a spatial state to movement action function,
a temporal state to movement action function,
a spatial-temporal state to spatial-temporal state function, or
a spatial-temporal state to movement action function.

5. The generative world model of claim 1, wherein the first spatial state comprises one or more spatio-temporal coordinates determined at least partially from sensor data acquired at a first time.

6. The generative world model of claim 5, wherein the sensor data comprises an image acquired via an image sensor.

7. The generative world model of claim 5, wherein the spatio-temporal coordinates comprise one or more spatial coordinates and one or more temporal coordinates, wherein the one or more spatial coordinates are determined from the sensor data, and wherein the one or more temporal coordinates are acquired from the sensor data and the one or more spatial coordinates.

8. The generative world model of claim 5, wherein the first set of spatial or temporal movement actions are determined based on the one or more spatio-temporal coordinates and the sensor data.

9. The generative world model of claim 1, wherein the first set of one or more spatial or temporal movement actions comprises one or more instructions for changing a spatial state or a temporal state.

10. A method of training a generative world model that models time as a navigable dimension for spatio-temporal prediction, the method comprising:
receiving input data, from a training data set, wherein the input data includes:
(i) a plurality of measurements,
(ii) state metadata associated with the plurality of measurements, the state metadata including spatial metadata and temporal metadata, and
(iii) spatio-temporal instructions associated with the plurality of measurements;
determining a structured sequence from the input data, the structured sequence comprising a set of linked measurements from the plurality of measurements of the input data;
providing the structured sequence and the input data to an untrained generative world model; and
performing a training method to train the generative world model to learn a relationship between the structured sequence and one or more parameters of the input data.

11. The method of claim 10, wherein the generative world model comprises an autoregressive model.

12. The method of claim 10, wherein the plurality of measurements includes sensor data acquired from a sensor, the sensor data including one or more of the following:
image data,
depth data, or
acoustic data.

13. The method of claim 10, wherein the spatial metadata includes one or more of the following for each respective measurement: a current location, a heading, a pitch, a roll, a latitude, or a longitude, and wherein the temporal metadata includes a current time of the respective measurement.

14. The method of claim 10, wherein determining the structured sequence from the input data comprises linking adjacent measurements of the plurality of measurements based on the state metadata of the respective measurements and based on a compliance with one or more requirements of a first ruleset.

15. The method of claim 14, wherein the first ruleset comprises a set of allowable movements based on an environment associated with the plurality of measurements.

16. The method of claim 15, wherein the set of allowable movements is determined from the plurality of measurements.

17. A method of determining, with a generative world model that models time as a navigable dimension for spatio-temporal prediction, a second spatio-temporal state from a first spatio-temporal state, the method comprising:
receiving the first spatio-temporal state, and
navigating from the first spatio-temporal state to the second spatio-temporal state, different from the first spatio-temporal state, wherein:
navigating from the first spatio-temporal state to the second spatio-temporal state includes determining a trajectory through a time dimension and determining the second spatio-temporal state based on the determined trajectory and the first spatio-temporal state,
the first spatio-temporal state comprises one or more of the following: a first temporal state, a first spatial state, or a first set of one or more spatial or temporal movement actions; and
the second spatio-temporal state comprises one or more of the following: a second temporal state, a second spatial state, or a second set of one or more spatial or temporal movement actions.

18. The method of claim 17, wherein the second spatio-temporal state includes the second set of one or more spatial or temporal movement actions, and wherein the method further comprises:
providing the one or more spatial or temporal movement actions as an instruction to a control mechanism of a device.

19. A non-transitory computer readable storage medium storing one or more programs, the one or more programs comprising instructions, which when executed by one or more processors of an electronic device, cause the electronic device to:
receive input data, from a training data set, wherein the input data includes:
(i) a plurality of measurements,
(ii) state metadata associated with the plurality of measurements, the state metadata including spatial metadata and temporal metadata, and
(iii) spatio-temporal instructions associated with the plurality of measurements;
determine a structured sequence from the input data, the structured sequence comprising a set of linked measurements from the plurality of measurements of the input data;
provide the structured sequence and the input data to an untrained generative world model; and
perform a training method to train a generative world model to learn a relationship between the structured sequence and one or more parameters of the input data.

20. A non-transitory computer readable storage medium storing one or more programs, the one or more programs comprising instructions, which when executed by one or more processors of an electronic device, cause the electronic device to:
receive a first spatio-temporal state, and
navigate from the first spatio-temporal state to a second spatio-temporal state, different from the first spatio-temporal state, wherein:
navigating from the first spatio-temporal state to the second spatio-temporal state includes determining a trajectory through a time dimension and determining the second spatio-temporal state based on the determined trajectory and the first spatio-temporal state,
the first spatio-temporal state comprises one or more of the following: a first temporal state, a first spatial state, or a first set of one or more spatial or temporal movement actions; and
the second spatio-temporal state comprises one or more of the following: a second temporal state, a second spatial state, or a second set of one or more spatial or temporal movement actions.
